(19) United States
(12) Patent Application Publication
(10) Pub. No.: US 2006/0044726 A1
(43) Pub. Date: Mar. 2, 2006

(54) Controlling circuit of power semiconductor device and controlling integrated circuit

(75) Inventors: Hiroshi Sakata, Tokyo (JP); Shinya Shirakawa, Tokyo (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MITSUBISHI DENKI KABUSHIKI KAISHA, Tokyo (JP)

(21) Appl. No.: 11/028,732

(22) Filed: Jan. 5, 2005

(30) Foreign Application Priority Data
Sep. 2, 2004 (JP) 2004-255490

(51) Int. Cl. H02H 3/00

(52) U.S. Cl. 361/100

(57) ABSTRACT

A shunt voltage that is generated at a shunt resistor (50) is input to overcurrent detecting means (22). When detecting an overcurrent, the overcurrent detecting means (22) inputs a current abnormality signal indicative of a current abnormality to reset signal outputting means (24). The reset signal outputting means (24) stores the occurrence of abnormality from the received current abnormality signal, and waits for recovery from the abnormality afterward. Then, when an overcurrent is no longer detected from the received current abnormality signal, the reset signal outputting means (24) determines that recovery from the abnormality has taken place, and inputs a reset signal composed of a pulse signal of H level for starting the operation to a fault signal output circuit (17) through a reset terminal (RESET). The fault signal output circuit (17) which has received the reset signal inputs a fault signal that has been shifted from L level to H level to a lower arm drive circuit (14).

### BACKGROUND OF THE INVENTION

1. Field of the Invention

The present invention relates to controlling circuits of power semiconductor devices and controlling integrated circuits, and more particularly to controlling circuits of power semiconductor devices and controlling integrated circuits having a protective function.

2. Description of the Background Art

A description will be given of a conventional controlling circuit of a power semiconductor device that performs control of a multiphase motor and the like by using an IGBT element and the like. In a control IC used in such controlling circuit of a power semiconductor device, a current detection signal input from a control microcomputer through a current detection terminal is input to an overcurrent detection circuit. The overcurrent detection circuit, when detecting an overcurrent from the received current detection signal, inputs a current abnormality signal indicative of a current abnormality to a fault signal output circuit. The fault signal output circuit which has received the current abnormality signal outputs a fault signal to stop the operation, and inputs the fault signal to the control microcomputer through a fault terminal. The control microcomputer interrupts the input of a control signal to the control IC based on the received fault signal. The pulse width of this fault signal is set inside the control IC and depends on the type of control IC, which is generally less than 100 μs and approximately 40 μs with a short one.

Control methods for protection against an overcurrent and the like are disclosed, for example, in Japanese Patent Application Laid-Open Nos. 2003-045637, 2001-161086, 9-199950 (1997), and 2001-231290.

In the conventional controlling circuit of a power semiconductor device where a fault signal having a short pulse width of generally less than 100 μs is input to a control microcomputer, as discussed above, a relatively expensive control microcomputer needs to be used in order to detect such short signal. This leads to an increase in cost of manufacturing the controlling circuit of a power semiconductor device.

### SUMMARY OF THE INVENTION

It is an object of the present invention to provide a controlling circuit of a power semiconductor device and a controlling integrated circuit that allows a reduction in manufacturing costs.

A first aspect of the present invention is directed to a controlling circuit of a power semiconductor device that controls a power semiconductor device using a microcomputer through a controlling integrated circuit. In the controlling circuit of the power semiconductor device according to this first aspect, when detecting an abnormality from a current detection signal output from the power semiconductor device, the controlling integrated circuit turns off the power semiconductor device with a fault signal output from a fault signal output circuit included therein. When detecting recovery from the abnormality from the current detection signal, the microcomputer outputs a reset signal to cancel the fault signal.

In a second aspect of the present invention, a controlling integrated circuit includes an input circuit, a level shift circuit, a first drive circuit, a second drive circuit, an overcurrent detection circuit, and a fault signal output circuit. A control signal for controlling a power semiconductor element is input to the input circuit. The level shift circuit converts the output from the input circuit into a plurality of levels. The first drive circuit outputs a first drive signal toward a first power semiconductor element based on the output from the level shift circuit. The second drive circuit outputs a second drive signal toward a second power semiconductor element based on the output from the level shift circuit, while suspending the output of the second drive signal when a received fault signal shifts from an inactive state to an active state. The overcurrent detection circuit outputs an abnormality signal based on a current detection signal which is based on the second power semiconductor element. The fault signal output circuit shifts the fault signal to the active state when the abnormality signal is output from the overcurrent detection circuit, and shifts the fault signal to the inactive state when detecting a reset signal input from outside.

The operation of the controlling integrated circuit recovers based on a pulsed reset signal output from the microcomputer. The microcomputer, which only needs to make a comparison with a prescribed threshold value in order to detect an overcurrent, can be structured at lower cost when compared to the one that detects a pulse signal having a short width. This permits a reduction in manufacturing costs.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the configuration of a power semiconductor device and a controlling circuit thereof according to a first preferred embodiment of the present invention; and

FIGS. 2A to 2E are timing charts illustrating the operation of the power semiconductor device and the controlling circuit thereof according to the first preferred embodiment.

### DESCRIPTION OF THE PREFERRED EMBODIMENTS

### FIRST PREFERRED EMBODIMENT

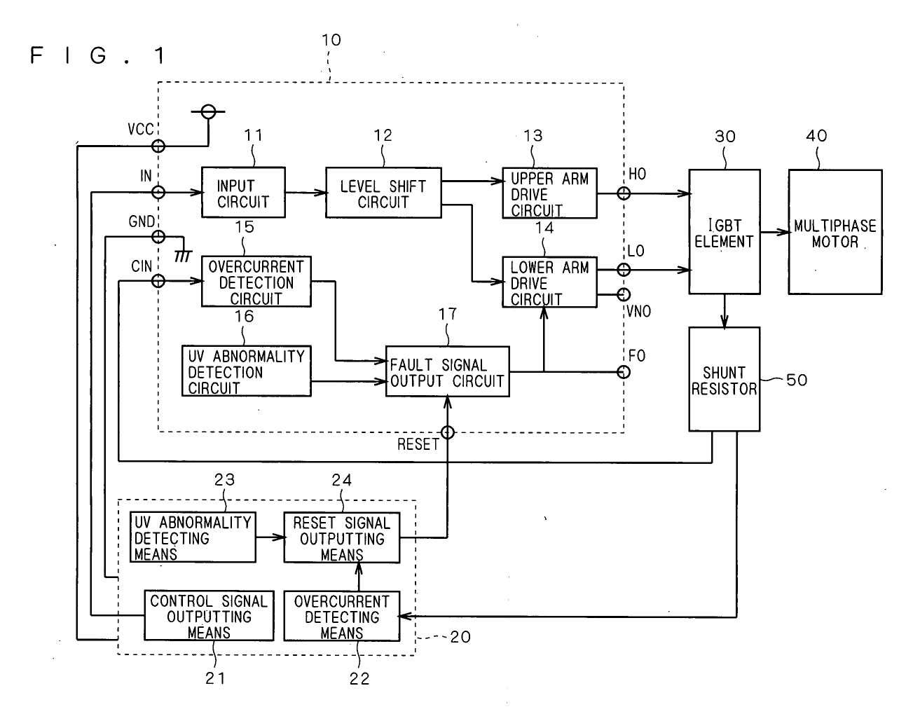

FIG. 1 is a block diagram illustrating the configuration of a power semiconductor device and a controlling circuit thereof according to a first preferred embodiment.

In FIG. 1, the power semiconductor device includes an IGBT element 30 (power semiconductor element), a multiphase motor 40, and a shunt resistor 50. The controlling circuit includes a control IC 10 (controlling integrated circuit), and a control microcomputer 20. The control IC 10 includes an input circuit 11, a level shift circuit 12, an upper arm drive circuit 13 (first drive circuit), a lower arm drive circuit 14 (second drive circuit), an overcurrent detection circuit 15, a UV abnormality detection circuit 16, and a fault signal output circuit 17. The control microcomputer 20 is composed of a microcomputer including not shown CPU, ROM and RAM, and operates in accordance with a software program stored previously in the ROM. As shown in FIG. 1, the control microcomputer 20 includes control signal outputting means 21, overcurrent detecting means 22, UV abnormality detecting means 23, and reset signal outputting means 24. The control IC 10 and the control microcomputer 20 are supplied with a drive potential VCC and a ground potential GND.

In FIG. 1, a control signal output from the control signal outputting means 21 is input to the input circuit 11 through an input terminal IN, and then input from the input circuit 11 to the level shift circuit 12. The level shift circuit 12 outputs a high-potential side control signal and a low-potential side control signal based on the received control signal, which are input to the upper arm drive circuit 13 and the lower arm drive circuit 14, respectively. The upper arm drive circuit 13 and the lower arm drive circuit 14 output a high-potential side drive signal (first drive signal) and a low-potential side drive signal (second drive signal) based on the received high-potential side control signal and low-potential side control signal, respectively, which are input to the IGBT element 30 through a high-potential side drive terminal HO and a low-potential side drive terminal LO, respectively, to be used for control of the multiphase motor 40. The lower arm drive circuit 14 is supplied with a reference potential through a reference potential terminal VNO.

A shunt voltage that is generated at the shunt resistor 50 connected to the IGBT element 30 is input, as a current detection signal, to the overcurrent detection circuit 15 through a current detection terminal CIN. The overcurrent detection circuit 15 makes a comparison between the received shunt voltage and a prescribed threshold voltage, and when the shunt voltage is higher than the threshold voltage, determines that an overcurrent has flown. When detecting an overcurrent, the overcurrent detection circuit 15 outputs a current abnormality signal toward the fault signal output circuit 17.

The UV abnormality detection circuit 16 makes a comparison between a divided voltage of the drive potential VCC and a prescribed threshold voltage, and when the divided voltage is higher than the threshold voltage, determines that a UV abnormality has occurred. When detecting a UV abnormality, the UV abnormality detection circuit 16 outputs a UV abnormality signal toward the fault signal output circuit 17.

The high-potential side drive signal output from the upper arm drive circuit 13 is input, for example, to three IGBTs (first power semiconductor element) connected in parallel in the IGBT element 30. Likewise, the low-potential side drive signal output from the lower arm drive circuit 14 is input, for example, to three IGBTs (second power semiconductor element) connected in parallel in the IGBT element 30. The former three IGBTs and the latter three IGBTs are connected in tandem, to form an inverter circuit. The multiphase motor 40 is PWM (Pulse Width Modulation)-driven by this inverter circuit.

When detecting even either of an overcurrent and a UV abnormality, the fault signal output circuit 17 outputs a fault signal that has been shifted from H level (inactive state) to L level (active state) through a fault terminal FO, while inputting the fault signal to the lower arm drive circuit 14. The lower arm drive circuit 14 which has received the fault signal of L level interrupts and shifts the low-potential side drive signal to L level, which is output through the low-potential side drive terminal LO. This allows the operation to be stopped when an abnormality occurs.

The shunt voltage that is generated at the shunt resistor 50 is also input to the overcurrent detecting means 22. The overcurrent detecting means 22 makes a comparison between the received shunt voltage and a prescribed threshold voltage, and when the shunt voltage is higher than the threshold voltage, determines that an overcurrent has flown. When detecting an overcurrent, the overcurrent detecting means 22 outputs a current abnormality signal toward the reset signal outputting means 24.

The UV abnormality detecting means 23 makes a comparison between a divided voltage of the drive potential VCC and a prescribed threshold voltage, and when the divided voltage is higher than the threshold voltage, determines that a UV abnormality has occurred. When detecting a UV abnormality, the UV abnormality detecting means 23 outputs a UV abnormality signal toward the reset signal outputting means 24.

The reset signal outputting means 24 stores the occurrence of abnormality from the received current abnormality signal or UV abnormality signal, and waits for recovery from the abnormality afterward. Then, when neither of an overcurrent and a UV abnormality is no longer detected from the received current abnormality signal and UV abnormality signal, the reset signal outputting means 24 determines that recovery from the abnormality has taken place, and inputs a reset signal composed of a pulse signal of H level for starting the operation to the fault signal output circuit 17 through a reset terminal RESET. The fault signal output circuit 17 which has received the reset signal inputs a fault signal that has been shifted from L level to H level to the lower arm drive circuit 14. The lower arm drive circuit 14 which has received the fault signal of H level cancels the interruption of the low-potential side drive signal. This allows the operation to start when recovery from an abnormality takes place.

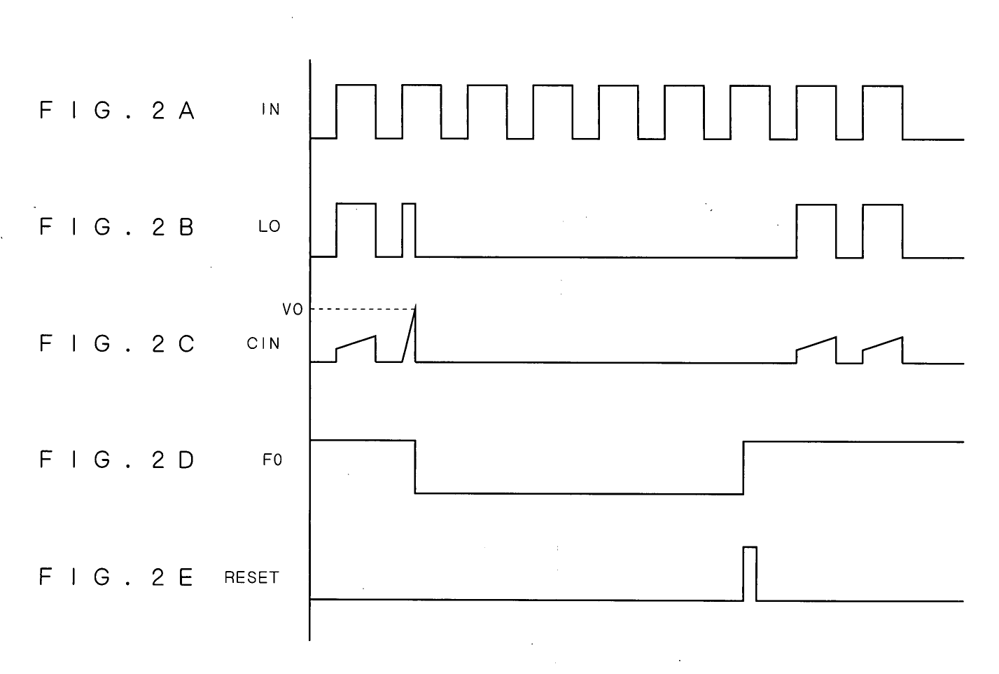

FIGS. 2A to 2E are timing charts illustrating the operation of the power semiconductor device and the controlling circuit thereof indicated in FIG. 1.

FIG. 2A indicates the input signal to the input terminal IN from the control microcomputer 20. A pulse signal is periodically input to the input terminal IN regardless of the presence or absence of abnormality. FIG. 2B indicates the low-potential side drive signal output from the low-potential side drive terminal LO toward the IGBT element 30. The low-potential side drive signal, which under normal conditions is a pulse signal in synchronization with the input signal, assumes L level when an overcurrent occurs, until the reset signal is input.

Next, when an overcurrent occurs and the current detection signal input through the current detection terminal CIN reaches a threshold potential V0, as indicated in FIG. 2C, the fault signal output through the fault terminal FO falls to L level, as indicated in FIG. 2D. The lower arm drive circuit 14 which has received the fault signal of L level interrupts and shifts the low-potential side drive signal to L level, which is output through the low-potential side drive terminal LO.

As indicated in FIGS. 2D and 2E, the fault signal that has fallen to L level is maintained at L level until the reset signal composed of a pulse signal of H level is input to the fault signal output circuit 17. Upon detecting recovery from the overcurrent from the current abnormality signal output from the overcurrent detecting means 22, the reset signal outputting means 24 inputs the reset signal to the fault signal output circuit 17. The fault signal output circuit 17 which has received the reset signal shifts the fault signal up to H level. This allows the lower arm drive circuit 14 to cancel the interruption of the low-potential side drive signal from the next cycle.

Although FIG. 2 refers to the case of an overcurrent abnormality, the similar operation can be performed in the case of a UV abnormality as well, by using the UV abnormality signal instead of the current abnormality signal.

In such ways, the operation of the control IC 10 recovers based on a pulsed reset signal output from the control microcomputer 20. The control microcomputer 20, which only needs to make a comparison with a prescribed threshold value in order to detect an overcurrent, can be structured at lower cost when compared to the one that detects a pulse signal having a short width. This permits a reduction in cost of manufacturing the controlling circuit of the power semiconductor device.

Further, in the controlling circuit of the power semiconductor device according to this embodiment, the interruption of the low-potential side drive signal is cancelled when recovery from an abnormality takes place, by using the overcurrent detecting means 22 and the UV abnormality detecting means 23 included in the control microcomputer 20 as well as the overcurrent detection circuit 15 and the UV abnormality detection circuit 16 included in the control IC 10. This reduces the possibility of canceling the interruption based on improper determination that recovery has taken place, when the current detection signal or the drive potential VCC temporarily takes on a normal value notwithstanding the cause of the abnormality is still not removed. Consequently, a short circuit or the like resulting from such malfunction, and failures or the like resulting therefrom can be prevented.

Particularly, in the case of a UV abnormality which is hardly a temporary abnormality but often requires a recovery job, the number of malfunctions can be reduced substantially by starting the operation based on the reset signal from the control microcomputer 20.

Additionally, in the conventional controlling circuit of a power semiconductor device, an arm short-circuit occurred sometimes at turn-on between upper and lower arm drive circuits. In the controlling circuit of the power semiconductor device according to this preferred embodiment, a UV abnormality due to fluctuations in the drive potential VCC at turn-on can be detected more precisely thus reducing the occurrence of such arm short-circuit at turn-on. This offers enhanced reliability.

In the above description, the output of the low-potential side drive signal from the lower arm drive circuit 14 is interrupted based on the current abnormality signal from the overcurrent detection circuit 15 and the UV abnormality signal from the UV abnormality detection circuit 16. In addition to this, the output of the control signal from the control signal outputting means 21 may be interrupted simultaneously based on the current abnormality signal from the overcurrent detecting means 22 and the UV abnormality signal from the UV abnormality detecting means 23.

Furthermore, although being output from the control microcomputer 20 in the above description, the reset signal may be output from a device other than the control microcomputer 20.

While the invention has been shown and described in detail, the foregoing description is in all aspects illustrative and not restrictive. It is therefore understood that numerous modifications and variations can be devised without departing from the scope of the invention.

What is claimed is:

1. A controlling circuit of a power semiconductor device that controls a power semiconductor device using a microcomputer through a controlling integrated circuit, wherein
when detecting an abnormality from a current detection signal output from said power semiconductor device, said controlling integrated circuit turns off said power semiconductor device with a fault signal output from a fault signal output circuit included therein, and
when detecting recovery from the abnormality from said current detection signal, said microcomputer outputs a reset signal to cancel said fault signal.

2. A controlling integrated circuit comprising:
an input circuit to receive a control signal for controlling a power semiconductor element;
a level shift circuit converting the output from said input circuit into a plurality of levels;
a first drive circuit outputting a first drive signal toward a first power semiconductor element based on the output from said level shift circuit;
a second drive circuit outputting a second drive signal toward a second power semiconductor element based on the output from said level shift circuit, while suspending the output of said second drive signal when a received fault signal shifts from an inactive state to an active state;
an overcurrent detection circuit outputting an abnormality signal based on a current detection signal which is based on said second power semiconductor element; and
a fault signal output circuit shifting said fault signal to said active state when said abnormality signal is output from said overcurrent detection circuit, and shifting said fault signal to said inactive state when detecting a reset signal input from outside.

3. The controlling integrated circuit according to claim 2, further comprising an abnormality detection circuit detecting an abnormality of a drive potential for driving said power semiconductor element, wherein
said fault signal output circuit shifts said fault signal to said active state when said abnormality detection circuit detects an abnormality.
